(19) United States
(12) Patent Application Publication
(10) Pub. No.: US 2008/0078199 A1
(43) Pub. Date: Apr. 3, 2008

(54) Refrigerated Container with a Closing and/or Opening Device and Corresponding Method

(76) Inventors: Mehmet Atas, Aachen (DE); Michael Cron, Aachen (DE)

Correspondence Address: COLLARD & ROE, P.C., 1077 NORTHERN BOULEVARD, ROSLYN, NY, 11576, US

(21) Appl. No.: 11/659,987

(22) PCT Filed: Jul. 26, 2005
(86) PCT No.: PCT/EP05/08102

§ 371 Date: Mar. 7, 2007

(30) Foreign Application Priority Data
Aug. 12, 2004 (DE) 10 2004 039 323.0

(51) Int. Cl. F25D 23/02; E06B 5/00

(52) U.S. Cl. 62/382; 49/506

(57) ABSTRACT

A refrigerated container and an associated method for closing or opening a removal cross-section of a refrigerated container by at least one laterally guided and displaceable cover element are known. The closing and/or opening procedure is initiated automatically using a closing and/or opening device after a specific time span and either automatically ended by reaching the closed position or the open position or automatically interrupted by a force component of an interfering force which counteracts the particular lateral movement and exceeds a threshold value.

It is disclosed here that a frictional connection and/or form fit between the cover element and/or the refrigerated container and/or the closing and/or opening device is advantageously neutralized outside the time of the automatic closing and/or opening procedure, to thus allow manual displacement of the cover element without having to apply an additional manual force corresponding to the threshold value.

The present invention relates to a refrigerated container having a removal cross-section and at least one laterally guided and displaceable cover element for closing the removal cross-section, which is transferable from an open position, in particular a product removal position, in which an intermediate space is provided between a closure side of the refrigerated container or a further cover element and a closure side of the cover element, into a closed position, in which there is essentially no intermediate space between the closure side of the refrigerated container or the further cover element and the closure side of the cover element, an automatic closing and/or opening procedure being able to be initiated by a closing and/or opening device and being able to be automatically ended after a predefinable time span by reaching either the closed position or the open position or being automatically interruptible by a force component of an interfering force which counteracts the lateral movement and exceeds a threshold value, as well as a method for this purpose.

Refrigerated containers of the type cited at the beginning are known, for example, from DE 101 18 437 A1, in which the cover elements of a refrigerated chest are coupled using a cable or belt system to a closing and/or opening device in the form of a drive. Further closing and/or opening devices, such as direct drives via gearwheels or toothed racks, friction wheels and/or hydraulic or pneumatic cylinders, are also cited in DE 101 18 437 A1. Manual displacement of the cover is not provided in DE 101 18 437 A1.

Furthermore, a sliding cover closure in refrigerated and freezer chests is known from DE 43 35 458 A1, which opens or closes the sliding cover using a closing and/or opening device in the form of an electric motor using a signal initiated by a movement detector. The force which is necessary for displacing the sliding cover is limited by a slip clutch. Furthermore, manual displacement is made possible, in particular in special cases, for example, in the event of a power failure.

DE 203 08 256 U1 discloses a furniture drive for moving a furniture element, a pinch protector and/or the ability to manually actuate it being ensured and/or formed by a slip clutch. Finally, a semicylindrical product display case is known from U.S. Pat. No. 3,599,371, which may be automatically opened and closed by actuating a pushbutton.

Therefore, automatically closing or opening a cover element of a refrigerated container from an open position after a time span, which may be set short in particular, is generally known, the air exchange which is necessary for icing and the disadvantages resulting therefrom only being able to occur in greatly shortened time spans. In particular, the automatic closing procedure or opening procedure only occurs when incorrect operation has occurred, i.e., if a person who has taken a product from or supplied a product to the interior of the refrigerated container, for example, has not or has not completely transferred the cover element into a closed position within the specific time span after removal and/or supply.

Although the automatic closing and/or opening procedure of the cited closing and opening devices is to contribute to lower power consumption, in order to preclude manual incorrect operation beforehand, such as unintentionally leaving the removal cross-section open, it is immediately obvious that more electrical power will be consumed for the automatic closing and/or opening procedure itself.

The object of the present invention is to suggest a method, which makes it possible for the power consumption to be reduced further, to lengthen the service life of the closing and/or opening device, and allows manually operable refrigerated chests to be equipped with an automatic closing and/or opening device.

Starting from the method of the type described at the beginning, the object is achieved in that a frictional connection and/or a form fit between the cover element and/or the refrigerated container and/or the closing and/or opening device is neutralized outside the time of the automatic closing and/or opening procedure.

By neutralizing the frictional connection and/or the form fit, the cover element may be manually displaced outside the closing procedure by a lateral movement which enlarges or reduces the intermediate space. Significant power and thus cost savings are made possible by the simple manual closing and/or opening procedure as the typical case, in contrast to the exclusively motorized displacement of the cover element, as provided in DE 101 18 437 A1, DE 43 35 458 A1, and U.S. Pat. No. 3,599,371. Nonetheless, incorrect manual behavior is compensated for, if doing so is advantageous, in order to prevent leaving the refrigerated container permanently open. Because, in contrast to the previously known cooling devices, the closing and/or opening device only comes into action when manual actuation does not occur, because it has been forgotten or intentionally not performed, the operating time of the closing and/or opening device is significantly shortened, so that the service life is lengthened and the maintenance outlay is reduced. In addition, it is perceived as pleasant by the customers to be able to perform the closing and/or opening procedure “rapidly” themselves and not having to wait for a possibly slow automatic movement. The present invention therefore allows the automatic displacement (i.e., performed by a drive) and the manual displacement of the cover element in parallel, the manual movement being able to be performed using minimum force effort, due to the decoupling during the shutdown times of the closing and/or opening device. In any case, overcoming additional frictional forces caused by the closing and/or opening device or resistances caused by a slip clutch is not necessary, so that a higher operating comfort results.

The frictional connection is defined in this context as a connection implemented in any way which allows a force to be transmitted. A frictional connection of this type may originate from a friction wheel, for example, which is drivable by an electric motor as a part of the closing and/or opening device. A direct force transmission, i.e., a direct frictional connection, occurs between the closing and/or opening device and the cover element, for example. An indirect force transmission, an indirect frictional connection, exists in this case between the refrigerated container and the cover element. Alternatively, the closing and/or opening device may also be attached to the cover element and the direct frictional connection may exist between the closing and/or opening device and the refrigerated container.

The form fit exerted by the closing and/or opening device is defined in this context as a formfitting engagement of a gearwheel, for example, which is drivable by an electric motor as a part of the closing and/or opening device, in a toothed rack. Formfitting connections arise due to at least two connection partners engaging in one another. The connection partners may not disengage from one another even without force transmission or in the event of interrupted force transmission by the closing and/or opening device due to the mechanical connection. The direct form fit exists in this case between the gearwheel as the first connection partner and the toothed rack as the second connection partner. An indirect form fit exists, however, between the cover element and the refrigerated container, for example, when, if the direct form fit exists, the electric motor which drives the gearwheel is connected to the cover element, and the toothed rack is attached to the refrigerated container.

The neutralization of the frictional connection and/or the form fit means that the formfitting and frictional connection between the connection partners is disengaged. A form fit between the cover element and/or the refrigerated container and/or the closing and/or opening device is neutralized outside the time of the automatic closing and/or opening procedure in this case. In this context, it is clear that solely turning off the electrical power for operating the closing and/or opening device does not necessarily indicate the neutralization of the frictional connection and/or the form fit, since the connection between the connection partners does not have to be disengaged in this case. A corresponding neutralization first exists when the cited connection partners disengage from one another. When the frictional connection and/or form fit is neutralized, it is thus no longer necessary to have to manually overcome internal frictional forces or torques of the closing and/or opening device.

As long as the closed position of the cover element is reached by manual actuation within the adjustable time span, the closing device remains inactive. Automatic interruption of the automatic closing procedure is advisable during the closing procedure when a person comes into contact with the cover element during this closing procedure. In particular, pinching of the hand or arm of the person between the closure side of the refrigerated container or a further cover element and the closure side of the cover element may be entirely precluded by the automatic interruption of the closing procedure. The interfering force may advantageously be detected electronically or also electromechanically by a slip clutch having signaling, for example.

The interruption is performed by a force component of an interfering force, which is actively or passively executed by the person, for example, and counteracts the lateral movement and exceeds a threshold value.

The time span advantageously begins to run after a movement of the cover element, in particular when the opening movement of the cover element is ended and/or interrupted, because the time for removing and/or supplying products from or to the refrigerated container is then independent of the time required for the opening procedure. Alternatively, the time span may also begin to run as soon as an end switch signals that the closed position of the cover element has been left.

An advantageous refinement of the present invention may be achieved by measuring the threshold value essentially permanently during the automatic closing procedure to provide the soonest possible interruption in the event an interfering force occurs.

A further advantage may be achieved if the specific time span is a function of whether the last performed closing procedure was ended or interrupted. The specific time span may be extended because of safety considerations, for example, if the last closing procedure was automatically interrupted and thus a (slight) danger exists, at least for a statistically ascertainable mean time span, that a person still has his hand or arm located in the interior of the refrigerated container and furthermore it is to be ensured that this person is out of the refrigerated container after expiration of the specific time span at a statistically determinable probability. However, if the last closing procedure was ended manually or automatically, a shorter specific time span may be set until initiating the closing procedure. The time span may be preselected using a typical time switch element or using a programmable microcontroller, multiple further functions for control and monitoring being able to be fulfilled in the latter case.

According to a refinement of the present invention, the force components may be ascertained by measuring a current absorbed by a drive device, by which an especially simple to implement and nonetheless adequately sensitive ability to detect the interfering force is provided. Finally, the method may be refined in that the threshold value of the force component of the interfering force which triggers interruption, in particular when the closing and/or opening device is first put into operation, is ascertained using at least one sensor detection of a voltage and/or a current during the automatic closing and/or opening procedure which is free of the interfering force and upon reaching the closed position or open position and using a program.

Differently performing closing and/or opening devices may also be shut down in the event of a determinable interfering force by automatically ascertaining the threshold value. Calibration of the closing and/or opening device by technicians may thus be dispensed with, so that the installation may also be performed in principle by auxiliary personnel.

The object of the present invention is also to suggest a refrigerated container which allows the method described to be applied.

The object is achieved by a refrigerated container, in which a frictional connection and/or a form fit between the cover element and/or the refrigerated container and/or the closing and/or opening device is neutralizable outside the time of the automatic closing and/or opening procedure. The advantages of the refrigerated container correspond to those of the method.

According to a refinement of the present invention, the closing device may be disconnectable by a switch, for example, for example, if the removal cross-section is to remain in the open position for a longer time during a longer-lasting filling or thawing procedure.

In addition, a refinement provides that a driver element is attachable to the cover element and is movable by the closing device laterally, in particular linearly lateral, in relation to the refrigerated container, which may additionally be tailored to the particular cover elements, in particular their handle elements, and/or may be folded up using a hinge.

The present invention may also be refined in that a driver element of a drive device is transferable from a release position, in which it is disengaged from a guide unit, into an engaged position, in which it is engaged with the guide unit. By coupling and decoupling the drive device to and from the guide unit, manual opening and closing of the refrigerated container may be performed without special force outside the closing procedure, i.e., during the decoupling.

It is also a refinement that the drive device is permanently attached to the refrigerated container and the guide unit is attached to the cover element, however, it is alternately preferable that the guide unit is permanently attached to the refrigerated container and the drive unit is attached to the cover element.

Moreover, it has been found that the drive element is transferable using an approach element of an approach device between the release position and the engaged position, since the coupling and decoupling may be automated especially easily using an approach element.

It is especially advantageous for specific applications if a switch is actuatable in the release position by the drive device and/or the approach element. The instantaneous setting of the drive device may always be kept extremely simply to query by the switch position and may be queried easily, for example, by an electronic comparison circuit. It is typically completely sufficient that two switching states may be specified by the switch position. In addition, the switch may be used for switching the supply current, for example, for the drive device or for an approach drive of the approach element, in that the drive device only drives the drive element, for example, when the switch is no longer in the switch position corresponding to the release position.

It is especially advantageous if the approach element is movable using an approach drive of the drive device, it being preferable if the approach drive is a servo unit having a drive disk having eccentrically situated pins, which engage in an oblong hole in the approach element, since a servo unit of this type represents a mass-produced product which may be purchased cost-effectively and which has already been used for many years in model construction.

A further refinement of the present invention is that the closing device has a carriage device movable along the guide element, which may be coupled to the cover element, in particular using the driver element. By using a movable carriage device, only the length of the guide element, which may be implemented as a toothed rack, for example, and, in addition, the driver element must be tailored to the particular refrigerated container. Basically the same closing device may be used for most refrigerated containers due to this easy adaptation, which is cost-effective to perform. Retrofitting of already existing refrigerated containers is thus also possible very easily.

In addition, in a refinement of the present invention, an end switch is attached to the refrigerated container or the closing device, which is actuated in the closed position by the carriage device and/or the cover element and may use the closed position for turning off the power supply to the drive unit especially easily.

In a refinement of the present invention, the carriage device may be supplied with electrical power using at least one power line, the supply lines being guided using an energy management unit, in particular a energy chain, comprising multiple chain links. Energy chains are a mass-produced product and are accordingly cost-effective to acquire. In general, they allow systematic, simple, safe, and nonetheless movable laying of lines.

In addition, a refinement of the present invention is achieved in that the refrigerated container has two cover elements which may slide one over another, each of which is provided with a carriage device, due to which they may be moved independently of one another and one end of each of which is connected to a shared and thus efficiently used energy management unit and, in addition, a shared guide rail and a shared guide element is provided for both carriage devices, the guide rail and the guide element being connectable to one another or implemented in one piece.

Finally, the present invention is to be refined in that the closing device may be covered by a lid, to which information and/or advertising elements or lighting units may be attached. The advantage may be seen in particular in that information and/or advertising elements in the form of price lists and complementary descriptions of the products are often attached to separate constructed bodies in known refrigerated containers, particularly in supermarkets, and therefore, by using a lid, not only are the other elements of the closing device protected from contamination, but rather in principle no additional space is necessary, because when typical supermarket refrigerated containers are equipped with the closing device according to the present invention, the cited constructed bodies may reasonably be dispensed with.

Of course, the advantageous closing and/or opening device may advantageously be used not only for refrigerated containers, but rather also for unrefrigerated product display cases or similar apparatus. Those skilled in the art will also be able to transfer the cited advantages easily from cover elements to further closing elements such as sliding doors. Moreover, instead of or in addition to the preferred electrical and electromechanical components, hydraulic components may also be used for the closing and/or opening device, for example, without leaving the scope of the present invention. Thus, it would be conceivable in principle to equip a hydraulic cylinder with an activatable solenoid valve, which may depressurize the hydraulic cylinder and thus neutralize a frictional connection.

A refrigerated container according to the present invention will be explained in greater detail on the basis of an exemplary embodiment.

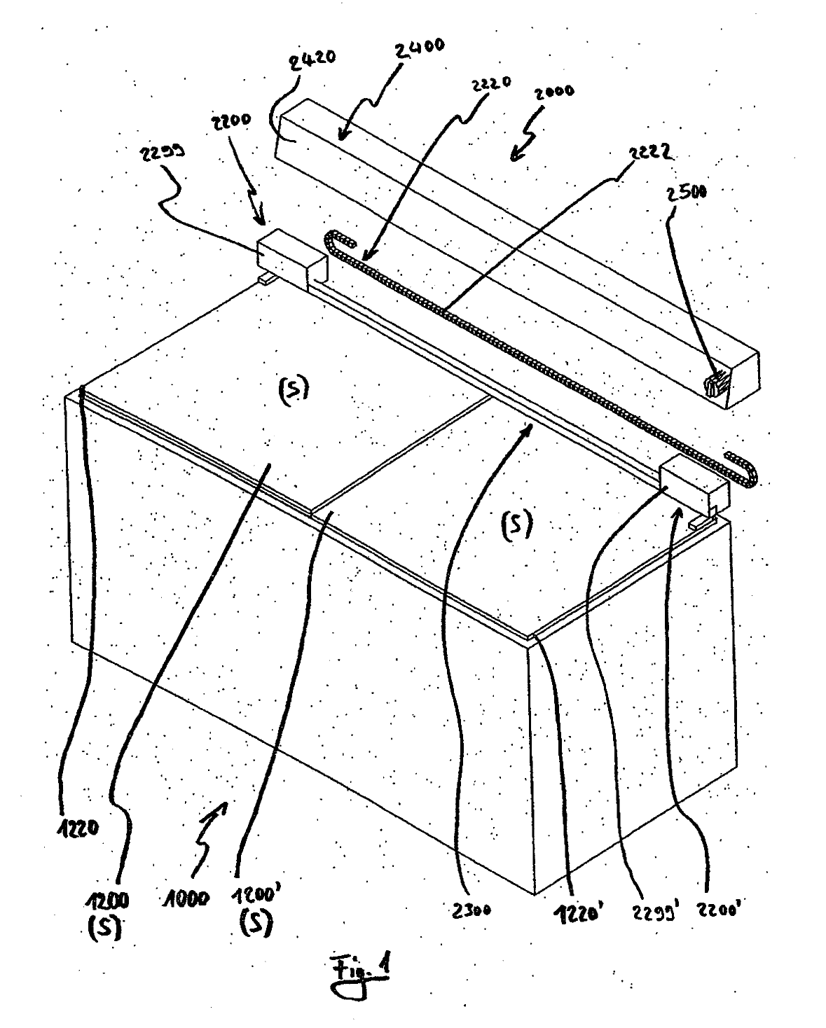

FIG. 1 schematically shows a perspective view of a refrigerated container according to the present invention having a closing device in a closed position,

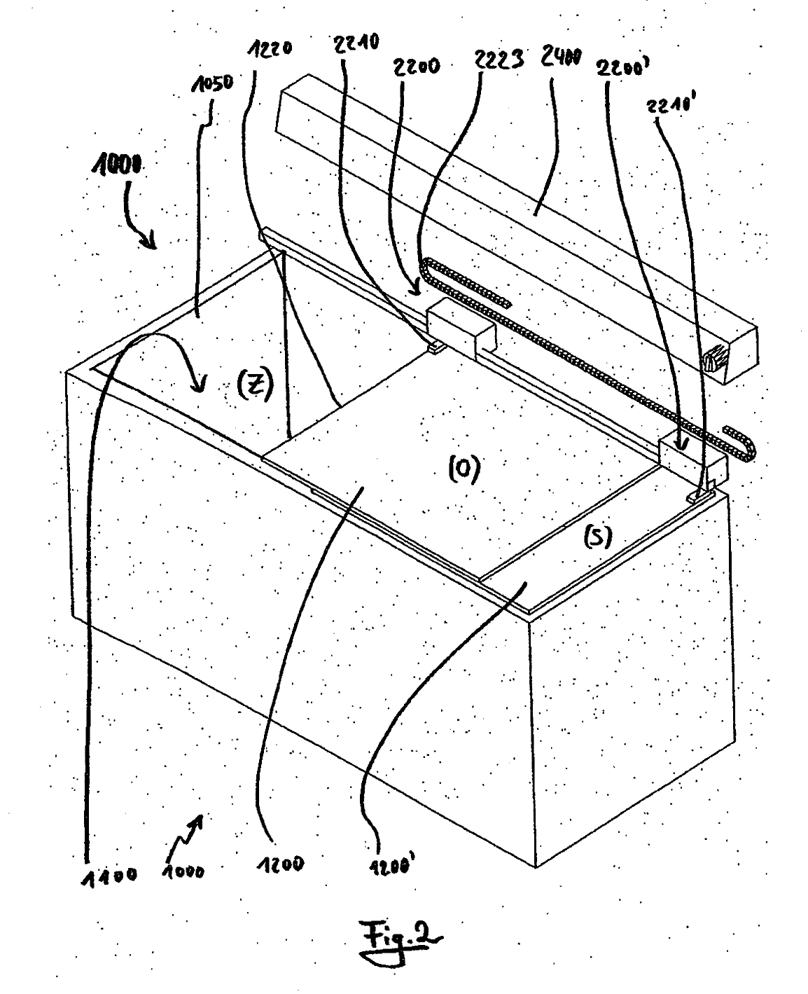

FIG. 2 schematically shows the refrigerated container from FIG. 1, but in an open position,

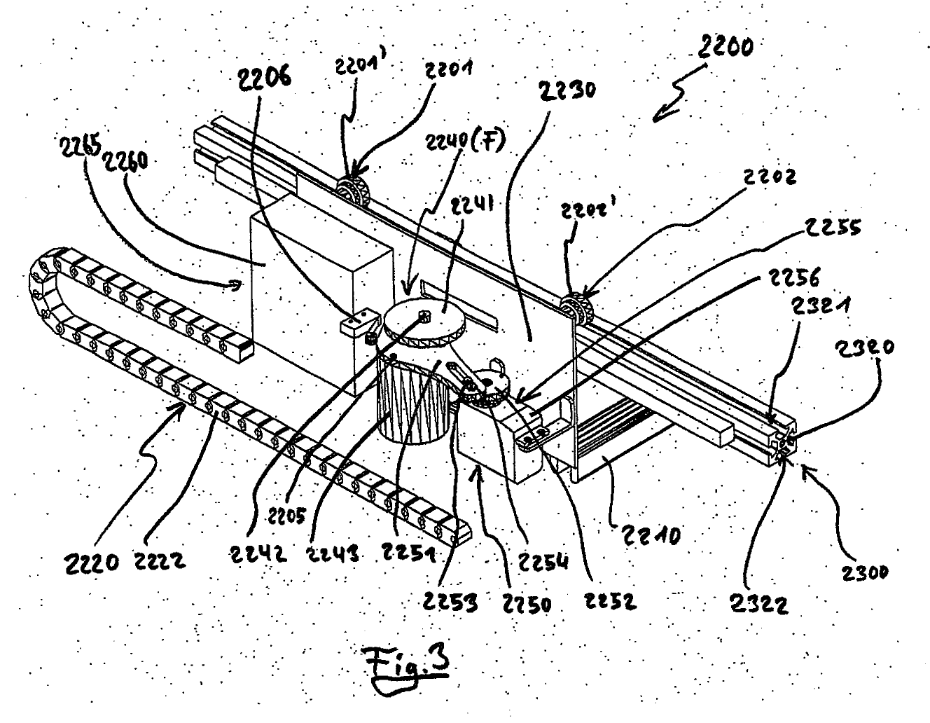

FIG. 3 schematically shows a perspective view of a carriage device in a release position of a drive element,

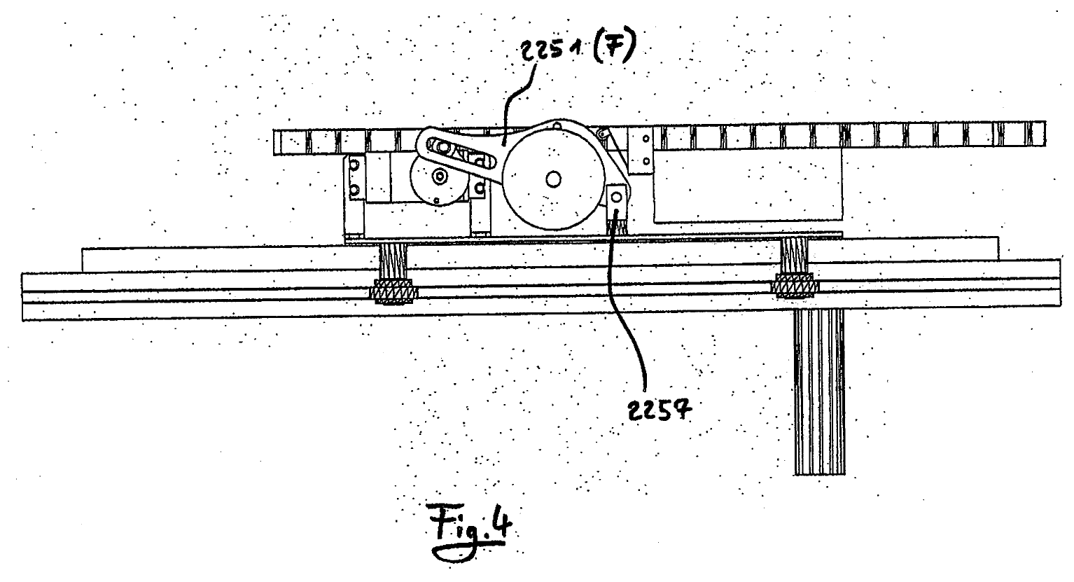

FIG. 4 schematically shows a top view of the carriage device from FIG. 3,

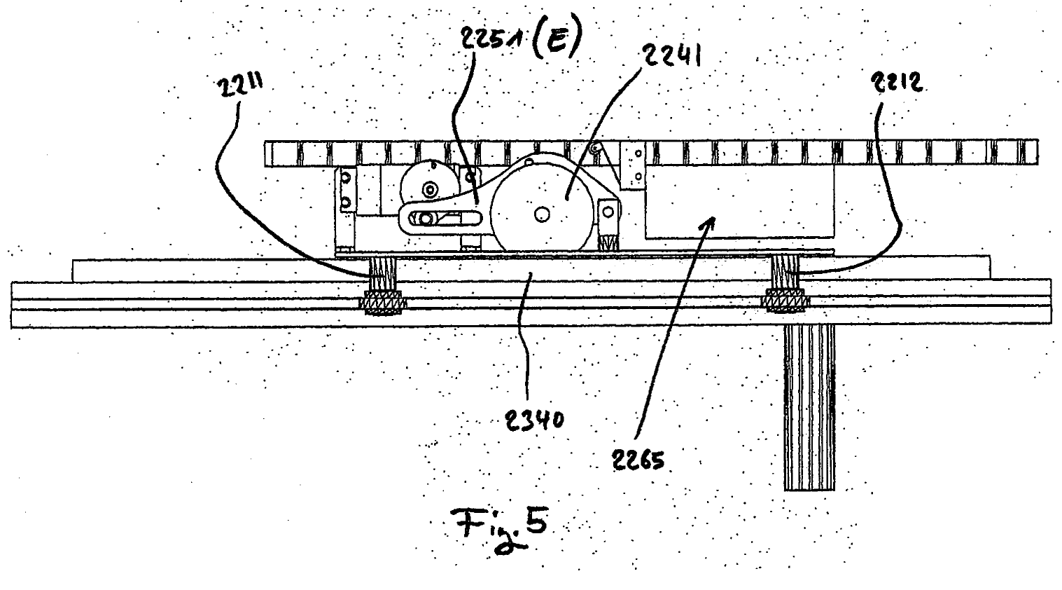

FIG. 5 schematically shows the carriage device from FIG. 4, but in an engaged position of the drive element,

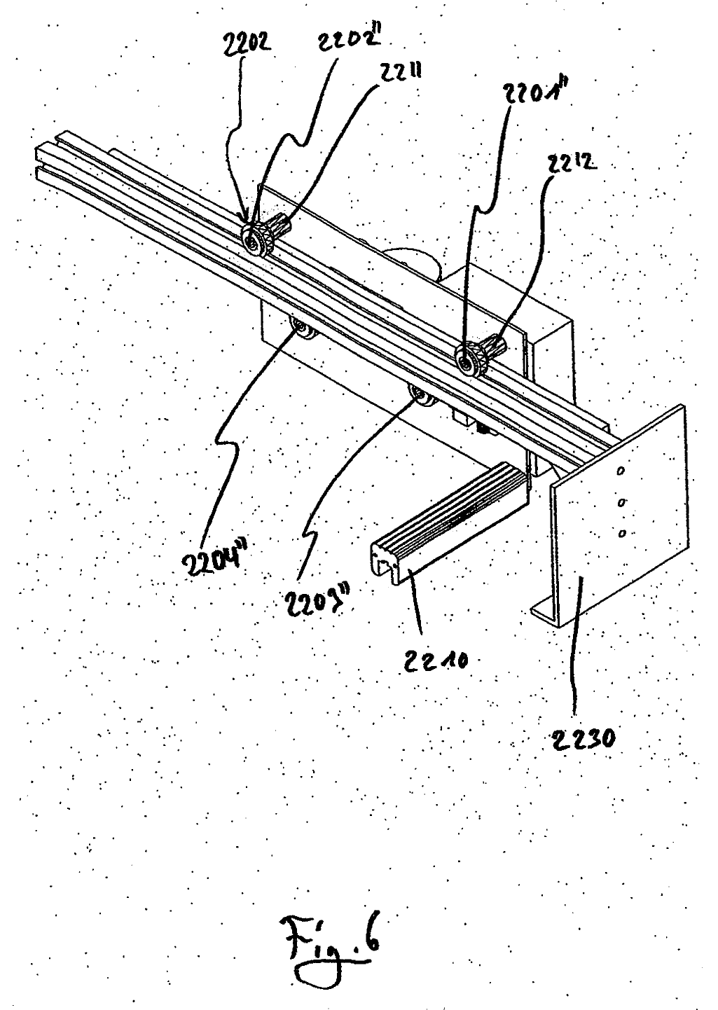

FIG. 6 schematically shows a perspective side view of the carriage device from FIG. 3, and

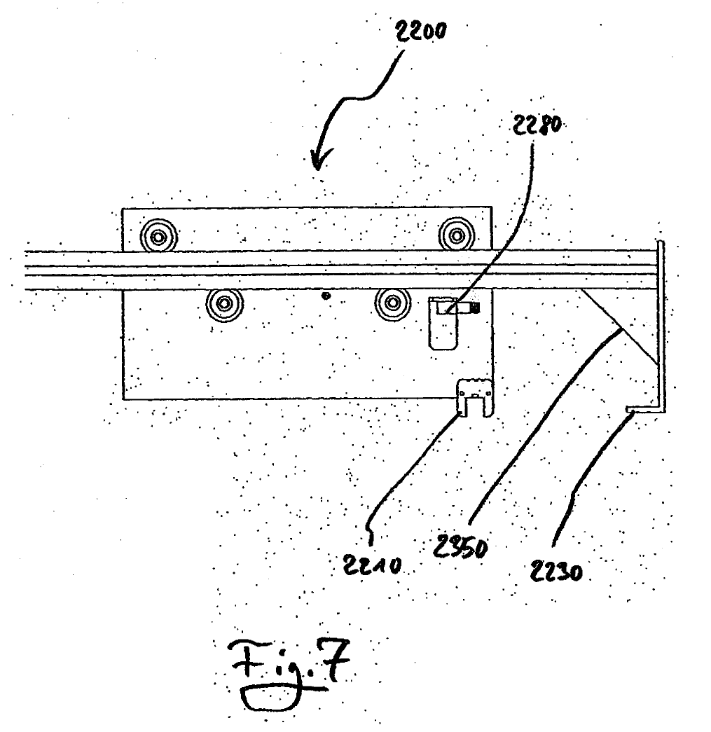

FIG. 7 schematically shows a side view of the carriage device from FIG. 3.

The refrigerated container 1000 shown in FIG. 1 in the form of a commercially available refrigerated chest has two cover elements 1200, 1200′, laterally guided by guide rails (not shown here), which are both located in a closed position S. In the closed position S, the closure sides 1220, 1220′ of the cover elements 1200,1200′ are drawn over the closure sides (not visible here), in particular the left and right interior sides of the refrigerated container 1000, in such a way that an intermediate space Z which may be reached through is no longer provided. The first cover element 1200 is mounted higher using its guide rail than the second cover element 1200′, so that it may be guided over the latter. Both cover elements 1200, 1200′ have seal elements (not shown here) on their closure sides 1220, 1220′, which ensure better partitioning of the cooled interior 1100, shown in FIG. 2, from the warmer surrounding air.

A closing device 2000 is also shown, which has two carriage devices 2200, 2200′ having cover hoods 2299, 2299′. The carriage devices 2200, 2200′ are movably guided along a guide unit 2300. The two carriage devices 2200, 2200′ are supplied with power via supply lines (not shown here), which are mounted in an energy management unit 2220 in the form of a energy chain having multiple chain links 2222. The entire closing device 2000 is covered by a lid 2400. The lid 2400 has a switch 2500 in the form of a rotary switch, using which the entire power supply for the closing device 2000 may be interrupted, on an information and advertising surface 2420, which is inclined at an angle of approximately 100° to the bases of the cover elements 1200, 1200′. The energy management unit 2220, the guide unit 2300, and the lid 2400 are shown separately from the remaining elements of the closing device 2000 for better visibility. Moreover, the closing device 2000 does not enlarge the area occupied by the refrigerated container 1000, so that two refrigerated containers 1000 having closing devices 2000 may be placed with their back sides (not visible here) flush to one another, for example, for the purpose of improved or equally good space use in aisles in supermarkets.

FIG. 2 shows the refrigerated container 1000 from FIG. 1, but partially in an open position 0, namely that of the first (left) cover element 1200. An intermediate space Z, which allows easy removal or positioning of products (not shown here) from or in the refrigerated container 1000 is thus located between the closure sides 1220 of the cover element 1200 and the (left) closure side 1050 of the refrigerated container 1000. The first carriage device 2200, which is coupled using a first driver element 2210 to the cover element 1200, is not located in a maximum achievable open position, however, but rather having a distance of half the length of the carriage device 2200 in front of it. In addition, the carriage device 2200 does not prevent the complete opening or closing of the cover element 1200 in any way. The second carriage device 2200′, which is coupled using the second driver element 2210′ to the second (right) cover element 1200′, is also located in the closed position S, as already shown in FIG. 1. The energy management unit 2220 is adapted to the new position of the carriage device 2200 in such a way that the peripheral left loop 2223 is located approximately between the left first and second quarter of the guide unit 2300 upon reaching the middle position of the carriage device 2200. The energy management unit 2220, the guide unit 2300, and the lid 2400 are also shown separately from the remaining elements of the closing device 2000 for better visibility in FIG. 2.

FIG. 3 shows the carriage device 2200, the guide unit 2300 (shown shortened), and the energy management unit 2220 (also shown shortened) having its individual chain links 2222 in detailed and enlarged form.

The carriage device 2200 runs, using four guide wheels 2201-2204 made of plastic, mounted on friction or ball bearings, in an upper and lower profile groove 2321, 2322 of a guide rail 2320, made of aluminum, of the guide unit 2300, each guide wheel 2201-2204 having a projecting shoulder 2201′-2204′, using which they each engage in the profile grooves 2321, 2322. The guide wheels 2201-2204 are attached to a support plate 2230 using screws 2201″-2204″ and tubular spacer elements 2211-2214 made of steel, which are shown in FIG. 6 and FIG. 7.

The driver element 2210, a drive device 2240, an approach device 2250, and a control and regulating device 2265, in the form of control and regulating electronics housed in a plastic housing 2260, are also attached to the support plate 2230. The drive device 2240 is shown in a release position F, in which a drive element 2241 in the form of a gearwheel is at a distance from a guide element 2340 of the guide unit 2300 in the form of a toothed rack made of steel or plastic. The direct form fit, which otherwise exists between the gearwheel as the first connection partner and the toothed rack as the second connection partner, is neutralized in the release position F. The drive element 2241 is connected to a motor shaft 2242 of a drive 2243. The drive 2243 is a 12-V DC voltage motor which receives its current from the control and regulating device 2265 via lines (not shown here). The drive 2243 is attached to a pivotably mounted approach element 2251 of the approach device 2250 using three screws, of which only one screw 2205 is shown. The approach element 2251 is pivoted by a drive disk 2252 of the approach device 2250 in that an eccentrically mounted pin 2253 of the drive disk 2252 engages in an oblong hole 2254 of the approach element 2251, the drive disk 2252 being driven by a servo unit 2255, comprising an electric motor (small gear motor) mounted in a plastic housing 2256.

The electric motor is a 6-V DC voltage motor, which receives its current, like the drive 2243, from the control and regulating device 2265 via lines (not shown here). The approach element 2251 is otherwise shaped in such a way that upon reaching a distance exceeding a threshold value in the release position F, a switch 2206 is actuated, which is electrically connected to the control and regulating device 2265 via lines (also not shown here), the power flow to the servo unit 2255 being interrupted by the switching procedure.

FIG. 4 shows the release position F of the approach element 2251, which is mounted pivotably on one side on a bearing fork 2257, once again especially clearly. The distance between the drive element 2241 and the guide element 2340 shown in

FIG. 4 is the maximum achievable distance, because the pin 2253, which engages in the oblong hole 2254 of the approach element 2251, is located in the greatest possible external position in relation to the guide element 2340. The carriage device 2200 may be displaced without special force application with the cover element 1200 in the release position F, because the carriage device 2200 and the cover element 1200 are coupled to one another by the driver element 2210, but drive element 2241 and guide element 2340 are disengaged.

FIG. 5 shows an engaged position E of the approach element 2251 with the guide element 2340. The distance between the drive element 2241 and the guide element 2340 is the minimum achievable distance, because the pin 2253 is located in an internal position having the smallest possible distance in relation to the guide element 2340 in this position. The carriage device 2200 may no longer be displaced manually with the cover element 1200 in the engaged position in the event of self-locking, or only with greatly increased force application, namely if the drive is not self-locking. There is a formfitting connection between the gearwheel and the toothed rack.

The engaged position E is only assumed after a time span adjustable on the control and regulating device 2265, and always when a closing procedure was not ended or was not ended correctly, in particular manually, or when a closing procedure was interrupted by manual action. The closing procedure is ended by actuation of an end switch 2280 shown in FIG. 7 using a switching angle 2350, which is attached between an angle element 2360 and the guide rail 2320. If actuation does not occur due to manual cover displacement, the closing procedure occurs automatically after a time span which is preferably preselected at approximately 7 seconds, in that first the servo unit 2255 moves the approach element 2251 from the release position F into the engaged position E and, simultaneously or a short time later, the drive 2243 is supplied with power, the drive element 2241 driving the carriage device 2200 with the cover element 1200 in relation to the guide element 2340 in the direction of the closed position S.

If, during the automatic closing procedure, a force component of an interfering force, which counteracts the lateral movement of the cover element 1200 accompanying the closing procedure and exceeds a threshold value, is applied, generated either by impact or contact with the cover element 1200, the drive current consumed by the drive 2243 is increased by a few to a few hundred milliamperes or microamperes. If this current increase exceeds the preset threshold value, the approach element 2251 having the drive 2243 attached thereto is immediately moved back into the release position and the power supply to the drive 2243 is simultaneously interrupted. An interruption signal may be output by suitable signaling means if desired. After a second time span, e.g., after 10 seconds, which is also selectable independently from the first time span, the automatic closing procedure described above is continued until reaching the closed position S. The actuation of the end switch 2280 by the switching angle 2350 indicates to the control and regulating device 2265 that the closed position has been reached properly.

FIGS. 6 and 7 illustrate the position of the guide wheels 2201-2204 on the support plate 2230. In addition, a U-profile of the driver element is shown. Using a first angle element 2360 and a second angle element diametrically opposite the first (not shown here), the entire closing device 2000 is attached to the refrigerated container 1000 using screws (also not shown here).

1. A method for closing or opening a removal cross-section of a refrigerated container (1000) by at least one laterally guided and displaceable cover element (1200, 1200′), the cover element (1200, 1200′) either being transferred from an open position (O), in particular a product removal position, in which there is an intermediate space (Z) between a closure side (1050) of the refrigerated container (1000) or a further cover element and a closure side (1220, 1220′) of the cover element (1200, 1200′), using a closing procedure, in which the cover element (1200, 1200′) is displaced, by a lateral movement which decreases the intermediate space (Z), into a closed position (S), in which there is essentially no intermediate space (Z) between the closure side (1050) of the refrigerated container (1000) or the further cover element and the closure side (1220, 1220′) of the cover element (1200, 1200′), or is transferred using a second lateral movement, which is directed opposite the first lateral movement and enlarges the intermediate space (Z), from the closed position (S) into the open position (O), the closing and/or opening procedure being initiated automatically using a closing and/or opening device (2000) and being ended automatically either by reaching the closed position (S) or the open position (O) or being automatically interrupted by a force component of an interfering force which counteracts the particular lateral movement and exceeds a threshold value, wherein a frictional connection and/or a form fit between the cover element (1200, 1200′) and/or the refrigerated container (1000) and/or the closing and/or opening device (2000) is neutralized outside the time of the automatic closing and/or opening procedure.

2. The method according to claim 1, wherein the closing and/or opening procedure particularly begins to run after a specific time span when a manual opening or closing movement of the cover element is ended or interrupted.

3. The method according to claim 1, wherein the closing and/or opening movement is automatically continued again after the interruption by the interfering force.

4. The method according to claim 1, wherein the threshold value of the force component of the interfering force which triggers the interruption is ascertained using at least one sensor detection of a voltage and/or a current during the interference-free automatic closing and/or opening procedure and upon reaching the closed position (S) or open position (o) and using a program, in particular when the closing and/or opening device (2000) is first put into operation.

5. A refrigerated container (1000) having a removal cross-section and at least one laterally guided and displaceable cover element (1200, 1200′) for closing the removal cross-section, which is transferable from an open position (O), in particular a product removal position, in which there is an intermediate space (Z) between a closure side (1050) of the refrigerated container (1000) or a further cover element and a closure side (1220, 1220′) of the cover element (1200, 1200′), into a closed position (S), in which there is essentially no intermediate space (Z) between the closure side (1050) of the refrigerated container (1000) or the further cover element in the closure side (1220, 1220′) of the cover element (1200, 1200′), an automatic closing and/or opening procedure being able to be initiated by a closing and/or opening device (2000) and being able to be ended automatically by reaching either the closed position (S) or the open position (O) or being able to be interrupted automatically by a force component of an interfering force which counteracts the lateral movement and exceeds a threshold value, wherein a frictional connection and/or a form fit between the cover element (1200, 1200′) and/or the refrigerated container (1000) and/or the closing and/or opening device (2000) is neutralizable outside the time of the automatic closing and/or opening procedure.

6. The refrigerated container (1000) according to claim 5, wherein the closing and/or opening device (2000) may be turned off by a switch (2500).

7. The refrigerated container (1000) according to claim 5, wherein a driver element (2210, 2210′) is attachable to the cover element (1200, 1200′) and is laterally movable, in particular linearly lateral, in relation to the refrigerated container (1000) by the closing and/or opening device (2000).

8. The refrigerated container (1000) according to claim 7, wherein the driver element (2210, 2210′) is adaptable to the particular cover elements (1200, 1200′), in particular their handle elements.

9. The refrigerated container (1000) according to claim 7, wherein the driver element (2210, 2210′) may be folded up using a hinge.

10. The refrigerated container (1000) according to claim 5, wherein a drive element (2241) of a drive device (2240) of the closing and/or opening device (2000) is transferable from a release position (F), in which it is disengaged from a guide unit (2300), into an engaged position (E), in which it is engaged with the guide unit (2300).

11. The refrigerated container (1000) according to claim 10, wherein the drive device (2240) is permanently attachable to the refrigerated container (1000) and the guide unit (2300) is attachable to the cover element (1200, 1200′).

12. The refrigerated container (1000) according to claim 10, wherein the drive element (2241) is transferable between the-release position (F) and the engaged position (E) using an approach element (2251) of an approach device (2250).

13. The refrigerated container (1000) according to claim 12, wherein a switch (2206) may be actuated by the drive device (2240) and/or the approach element (2251) in the release position (F).

14. The refrigerated container (1000) according to claim 12, wherein the approach element (2251) is movable using an approach drive of the drive device (2240).

15. The refrigerated container (1000) according to claim 14, wherein the approach drive is a servo unit (2255) having a drive disk (2252) having eccentrically situated pins (2253), which engage in an oblong hole (2254) in the approach element (2251).

16. The refrigerated container (1000) according to claim 5, wherein the closing and/or opening device (2000) has a control and/or regulating device (2265) in the form of control and regulating electronics, using which the time span and/or the threshold value are adjustable and exceeding the threshold value may be ascertained.

17. The refrigerated container (1000) according to claim 5, wherein the closing and/or opening device (2000) has a carriage device (2200, 2200′) movable along the guide element (2340), which may be coupled to the cover element (1200, 1200′), in particular using the driver element (2210, 2210′).

18. The refrigerated container (1000) according to claim 17, wherein the approach element (2251) is mounted on the refrigerated container (1000) or the carriage device (2200, 2200′) so it is pivotable.

19. The refrigerated container (1000) according to claim 17, wherein an end switch (2280) is attached to the refrigerated container (1000) or the closing device (2000), which is actuated in the closed position (S) by the carriage device (2200, 2200′) and/or the cover element (1200, 1200′).

20. The refrigerated container (1000) according to claim 17, wherein the refrigerated container (1000) has two cover elements (1200, 1200′), which are slidable one over the other, each of which is provided with a carriage device (2210, 2210′) and which are each connected at one end to a shared energy management unit.

21. The refrigerated container (1000) according to claim 17, wherein the carriage device (2210, 2210′) is guided so it is laterally movable on a guide rail (2320) using multiple guide wheels (2201-2204).
